(19) United States
(12) Patent Application Publication
(10) Pub. No.: US 2021/0318533 A1
(43) Pub. Date: Oct. 14, 2021

(54) SEEKER OPTICS, SEEKER HEAD AND GUIDED MISSILE

(71) Applicant: Diehl Defence GmbH & Co. KG, Jeberlingen (DE)

(72) Inventors: Jens Moeller, Owingen (DE); Franz Muenzhuber, Radolfzell am Bodensee (DE); Philipp Rotter, Nuernberg (DE)

(21) Appl. No.: 17/159,232

(22) Filed: Jan. 27, 2021

(30) Foreign Application Priority Data
Jan. 28, 2020 (DE) 102020000482.2

(51) Int. Cl. G02B 23/16; G02B 23/02; F41G 7/22

(52) U.S. Cl. CPC G02B 23/16; F41G 7/226; G02B 23/02

(57) ABSTRACT

Seeker optics are provided for a missile seeker head, in particular a guided missile seeker head. The seeker optics contain an optical system having at least one optical element, which is aligned so as to be positioned with respect to an optical axis and is held in at least one optics frame. The optics frame contains an actively shape-variable substance by which the location of the at least one optical element in the optical system can be varied relative to the optical axis and/or by which the shape of the optical element can be adaptively varied.

### CROSS-REFERENCE TO RELATED APPLICATION

This application claims the priority, under 35 U.S.C. § 119, of German patent application DE 10 2020 000 482, filed Jan. 28, 2020; the prior application is herewith incorporated by reference in its entirety.

### BACKGROUND OF THE INVENTION

### Field of the Invention

The underlying invention relates in particular to seeker optics, to a missile seeker head, and to a missile having such seeker optics.

Homing guided missiles generally have a guided missile seeker head with seeker optics, or input optics. A guided missile seeker head for a guided missile is known, for example, from published, European patent application EP 3 048 410 A1, corresponding to U.S. Pat. No. 9,709,361.

For precise target acquisition and target tracking, screening of the seeker optics against external influences is of crucial importance.

Against this background, it is an object of the invention to provide improved seeker optics for a missile, in particular a guided missile, and a missile seeker head, or guided missile seeker head, and a missile or guided missile having such seeker optics, which in particular are relatively robust against external influences.

### BRIEF SUMMARY OF THE INVENTION

This object is achieved by seeker optics, a missile seeker head, in particular a guided missile seeker head, and a missile, in particular a guided missile, according to the independent claims. Configurations of the invention may be found in the dependent claims and the following description of embodiments and exemplary embodiments.

In one embodiment, seeker optics for a (guided) missile seeker head are provided. The seeker optics comprise an optical system, for example at least one set of input optics, having at least one optical element, which is aligned so as to be positioned with respect to an optical axis and is held in at least one optics frame. The optics frame may be configured for holding one or more optical elements, in particular according to predetermined positions with respect or relative to the optical axis (axes) of the seeker optics. For example, one of the at least one optics frames may be configured as a holder or holding structure adapted to hold, fix and position one or more optical elements assigned to at least one optical stage of two-stage or multistage optics.

The optics frame may be adapted in such a way that it holds one or more optical elements of the seeker optics in a predetermined setpoint alignment, setpoint separation and/or setpoint position with respect to one another or relative to the optical axis. Without suitable countermeasures, however, for example because of thermal expansion or contraction at the material of the optics frame in the event of changes in the ambient temperature or other effects, for example production tolerances, it may occur that the position of the optical elements no longer corresponds to the predetermined setpoint alignment, setpoint separation or setpoint position. Such deviations degrade the imaging properties of the seeker optics and may lead to errors in the target acquisition and target tracking.

Particularly in order to be able to counteract such deviations, the optics frame proposed here for the seeker optics contains an actively shape-variable, i.e. responsive, substance.

The optics frame with a responsive substance is configured in such a way that the location of the optical element in the optical system relative to the optical axis can be varied, in particular adjusted, adaptively by the responsive substance, and/or that the shape of the optical element can be adaptively varied, or adjusted, by the responsive substance. In particular, the responsive substance may be configured in such a way, for example by suitable implementation in or on the optics frame, that the location, position, alignment and/or orientation of the optical element parallel, transversely, in particular radially and/or in the circumferential direction (rotationally) with respect to the optical axis can be adaptively varied. In this case, the location, particularly in terms of alignment and position, relative to the optical axis, or the imaging axis, and/or the shape of the optical element or elements can be varied, in particular adapted, by the responsive substance causing a shape change of the optics frame. For example, the responsive substance may comprise piezo crystals which, when a voltage is applied, cause a for example locally specific shape change of the optics frame.

On the basis of shape changes of the optics frame, for example the position, alignment or orientation of the optical elements relative to the optical axis, the imaging axis or the image plane may be adapted. Such adaptations may for example be described in a spherical coordinate system having a polar axis collinear with the optical axis by changes in the position or location in the radial direction with respect to the coordinate origin, by changes in relation to the polar angle and/or by changes in relation to the azimuthal angle of the spherical coordinate system. In particular, such adaptations may relate to the respective optical element as a whole, i.e. each volume element of the optical element experiences substantially the same coordinate change. It is furthermore possible for the coordinate changes to be different for different volume elements. The latter may, for example, be the case when an active shape change of the responsive material (also) causes a tilt of the optical element relative to the optical axis.

Changes in the shape of the optical element or elements are possible in particular when respective optical elements are shape-variable in such a way that they can be deformed by forces that act on the optical element or elements during the active shape change of the optics frame.

In the context of the invention, “adaptively variable” is intended in particular to mean that the optics frame, or at least a subregion or section of the optics frame, which contains the responsive substance or is formed therefrom, can be actively adapted to changing external situations, and/or that shape changes of the optics frame which are caused by in particular changing external influences, for example temperature changes, acceleration forces, etc., can be compensated for at least to a certain degree actively, in particular by corresponding control or regulation mechanisms or algorithms. In particular, “adaptively variable” is intended to mean that shape changes caused by thermally induced expansion/contraction of the optics frame can be actively compensated for at least to a certain degree, in particular to such an extent that a variation of the imaging properties of the optical system caused by the shape change of the optics frame can be compensated for or corrected. For example, the optics frame may be configured in such a way, and in particular the responsive material may be adapted in such a way, that thermally induced shape changes in a temperature range of between −55° C. and +85° C. can be compensated for. This may, for example, be achieved by inverse piezoactive materials, for example piezo crystals or piezo elements, which are provided on or in the material of the optics frame. When using inverse piezoactive materials, with a suitable elastic deformability of the optics frame, shape changes of the optics frame may for example be induced by the inverse piezo effect (for example when applying a voltage to the inverse piezoactive material).

An “actively shape-variable material”, i.e. a “responsive” material, is intended in particular to mean a material which, for example when an electric field, current and/or voltage is applied, and/or when a magnetic field is applied, is capable of changing its shape in response to the application, in particular without mechanical deformation forces generated by a source external to the material being required for the change of shape. In particular, “responsive” is also intended to mean that the shape of the material can be varied, in particular adjusted or adapted, by control technology or regulation technology. With a corresponding responsive material, it is for example possible to compensate at least partially for changing ambient conditions, for example temperature changes, by an actively adaptive shape change of the responsive material. As already mentioned, inverse piezoactive materials, for example but not exclusively, are suitable for the implementation of a responsive material.

The optics frame may be produced as a whole from the responsive material. As an alternative, it is also possible for merely sections or segments of the optics frame to be produced from the responsive material, or to comprise or consist of such a material.

With the proposed solution, seeker optics which are robust in relation to external influences such as temperature changes, acceleration forces and the like may in particular be provided. In particular, with suitable arrangement, provision or integration of the responsive material, any shape changes of the optics frame caused by thermal expansion or thermal contraction, and resulting location and position changes of the optical element or elements, may be compensated for at least partially, particularly in such a way that optimal imaging properties may be restored for the underlying optical system. In particular, it is possible to integrate the responsive material in or with the optics frame, or provide it thereon, or produce the optics frame from the responsive material, in such a way that location, alignment, position and/or shape changes of the optical elements in the respective optical system may be compensated for. In particular, with suitable integration or configuration of the responsive material, it is possible to compensate at least partially for location changes of optical elements relative to one another, in particular distance changes between optical elements. Furthermore, the responsive material not only allows compensation for environmental influences, but it may also be used in order to compensate at least partially for production tolerances and/or adjustment tolerances during the positioning of the optical elements. For example, after production of the optical system, in particular after mounting of the optical elements and assembly of the optical system, the optical system may be calibrated at least partially on the basis of the responsive material.

In one embodiment, the optics frame, in particular the shape-variable substance of the optics frame, may comprise a fiber-reinforced substance material, in particular a fiber-reinforced plastic material. In some configurations, it is possible for the optics frame, i.e. the optics frame per se or one or more sections of the optics frame, to be produced from the fiber-reinforced material.

In the fiber-reinforced substance material, in particular the plastic material, the substance material may form a matrix in which the fibers are embedded, for example along a predetermined preferential direction.

Fiber-reinforced substances are suitable in particular for the production of lightweight optics frames with relatively high mechanical stability, but still offer sufficient play for active shape changes. In particular, fiber-reinforced plastics may be equipped relatively easily with adaptively actively shape-variable properties, for example by integration of inverse piezoactive materials, for example piezoelectric crystals, electrostrictive materials and/or magnetostrictive materials. Such materials may, for example, be integrated or embedded in the substance according to a predetermined (density) distribution, alignment, etc., or provided on a surface or a near-surface layer of the optics frame, in order to obtain respectively desired adaptive properties of the optics frame at the micro and/or macro level.

In some embodiments, carbon fibers, glass fibers and basalt fibers may in particular be envisaged as fibers. By carbon fibers, inter alia, the conductivity as a physical property of the substance may be influenced. An increased conductivity may, for example, be advantageous when inverse piezoactive materials, electrostrictive materials, for example piezoelectric crystals, are embedded for the adaptive variability of the shape of the optics frame. By glass fibers and basalt fibers, it is for example possible to contribute (in particular locally) to structural reinforcement.

In some embodiments, the substance material may comprise at least one material selected from the following group: epoxy resins, vinyl ester resins, polyurethanes, polyether ketones polyether ether ketones. In the scope of some configurations, it is also possible for the substance material per se to consist of at least one material selected from the aforementioned group or mixtures thereof. The epoxy resin may to this extent be used as a matrix for embedding the fibers. In particular, the substance material, for example a plastic material, for example an epoxy resin, may be used as a matrix in which further substances or substance mixtures, for example inverse piezoactive, electrostrictive and/or magnetostrictive materials or crystals, by which the adaptively shape-variable properties of the optics frame are implemented, are embedded.

In some embodiments, the actively shape-variable substance forms an actuator unit, which for the active shape variation contains at least one inverse piezoactive material, at least one electrostrictive material and/or at least one magnetostrictive material.

The inverse piezoactive, electrostrictive and/or magnetostrictive materials may, for example, be embedded in a corresponding substance material from which the optics frame as a whole, or parts thereof, are produced. The embedding may in this case be implemented in such a way that the inverse piezoactive, electro- and/or magnetostrictive materials are present in the substance material according to a predetermined distribution, alignment and/or density, so that the respectively desired adaptive shape variability of the optics frame may correspondingly be adjusted. The embedding may in this case be carried out in such a way that the optics frame is shape-variable as a whole i.e. at the macro level, or locally specifically, in particular at the micro level.

As already mentioned, besides or in addition to embedding, is also conceivable for corresponding materials to be present on a surface of the optics frame.

In some configurations, the actively shape-variable substance may form an actuator unit which comprises inverse piezoactive materials, in particular piezoelectric crystals and/or fibers, as actuator elements, which in particular are embedded in the volume material of the optics frame while being aligned according to at least one preferential direction. The embedding may in this case be carried out uniformly through the bonding material or locally specifically, particularly in such a way that the respectively required shape variability of the optics frame can be implemented.

Uniform embedding, for example substantially equally distributed embedding, may be envisaged in particular when the substance material of the optics frame per se, at least to a certain degree, already exhibits adaptive deformation properties. If the substance material per se exhibits no adaptive deformation properties, or substantially no adaptive deformation properties, the embedding of the actuator elements can preferably be present according to a locally specific orientation and/or locally specific distribution.

In particular, it may be provided that the actuator unit forms an integral component of the optics frame. The actuator unit per se may be adapted, for example by suitably configured interfaces, in such a way that the actuator unit can be driven by means of command signals, or control or regulation signals, of an assigned control or regulation unit and, on the basis of the control signals, causes a defined shape change or position change of the optical element or elements.

A corresponding control unit may, for example, be adapted to record temperature values or receive measured temperature values, and to use the temperature values or values/quantities derived therefrom as a command quantity of the control. The same applies for other external influences, for example acceleration forces, in which case here suitable acceleration sensors may be used.

In order to record the temperature, one or more temperature sensors may be provided, which may be coupled to the optics frame for the temperature recording. For example, one or more thermocouples, resistance thermometers and/or semiconductor temperature sensors may be used as the temperature sensor. It is also possible to provide one or more fiber-optic temperature sensors (for example glass fibers as linear sensors), which are applied on the optics frame or are at least partially embedded therein. Acceleration values may, for example, be determined by suitable acceleration sensors.

A corresponding regulation unit may, for example, be adapted to record or receive data relating to the shape and/or 2D or 3D structure of the optics frame, and to use these data/quantities or data/quantities derived therefrom as a control quantity, regulation quantity of the regulation for regulating the location, shape or position of the optical elements. Data relating to the shape or structure of the optics frame, and associated therewith relating to the location, shape and/or position of the optical elements, may for example be recorded by means of strain gauge elements/strips and the like.

It is also possible to record or determine data relating to the location, shape or position of the optical elements by analysing/evaluating image data recorded or generated by the seeker optics with respect to possible imaging errors. Data relating to imaging errors may then, for example, be used as a control quantity of the regulation. According to one corresponding regulation method, the actuator unit may be regulated as a function of the control quantity on the basis of the imaging errors, in such a way that the imaging error or errors are at least reduced, and preferably eliminated. To this extent, seeker optics containing a corresponding actuator unit with regulation may be regarded as adaptive seeker optics which are capable of compensating at least for thermally induced shape changes and spatial deformations of the optics frame caused by accelerations, on the basis of the recorded images. In order to determine the imaging errors from the image data, suitable algorithms may be used, these being for example implementable on a corresponding regulation unit. In connection with corresponding regulation, furthermore, it is possible to implement algorithms, in particular electronically readable instructions, which cause a shape adaptation in order to compensate (at least) for thermally induced shape changes, etc., when carried out by the regulation unit.

In addition, it should be mentioned that besides thermally induced and acceleration-induced shape changes, mechanical tolerances may for example also be compensated for with such regulation, at least to a certain degree.

In some configurations, a control or regulation loop may be provided, by which the shape of the optics frame, or parts thereof, can be varied, in particular adapted, in a controlled or regulated way by active driving of the active shape-variable material.

According to some embodiments, the seeker optics may comprise at least one sensor unit. The sensor unit may, for example, be at least partially embedded in the volume material of the optics frame, applied on the surface of the optics frame or implemented separately from the optics frame. The sensor unit may, for example, be adapted to measure the ambient temperature and/or acceleration, in particular that at the site of the optics frame. The sensor unit may also be adapted to generate sensor signals characteristic of shape variations of the optics frame. In particular, the sensors and sensor types already described above may be envisaged. Characteristic sensor signals are, in particular, intended to mean ones which make it possible to determine, for example calculate, shape changes at the optics frame. One example of such a sensor signal is the temperature. On the basis of the measured temperature, or on the basis of measured temperature changes, a shape or shape change to be expected relative to a reference shape or reference temperature may be at least implicitly determined or calculated, for example on the basis of known or approximated thermal expansion coefficients of the material or materials or substance or substances of the optics frame. As an alternative to the shape or shape change, corresponding characteristic quantities may also be determined or calculated. Again on the basis of the determined or calculated shape, shape change and/or quantities, the shape of the actively shape-variable substance can be adaptively adapted in order to compensate for the shape change. The effect achievable because of the compensation for the shape change is that the location, position and/or shape of the optical element or elements in the optical system respectively correspond to predetermined setpoint values, so that degradations of the imaging characteristics of the optical system caused (in particular) by temperature changes may at least substantially be eliminated.

For example, the control unit/regulation unit may drive/regulate an actuator formed from the actively shape-variable substance, for example with electrical voltage, in such a way that the optical element or elements are positioned at respectively predetermined positions in the optical system and are suitably aligned. In particular, the actively shape-variable substance, in particular the actuator unit, may be driven in such a way that it counteracts a thermal expansion or contraction and/or shape change caused by acceleration, and the location, in particular the mutual distance of the optical element or elements, or their position in the optical system, corresponds to the respectively desired setpoint values.

According to one embodiment, the sensor unit may comprise as sensor elements piezoelectric crystals, piezoelectric fibers and/or one or more resistive strain gauge strips, inductive displacement sensors, inductive distance sensors, magnetoelastic sensors, capacitive differential sensors and/or fiber-optic temperature sensors. Such sensor elements allow relatively accurate and reliable determination of thermally induced shape changes of the surrounding material. As an alternative or in addition, the sensor unit may also comprise one or more temperature sensors. With respective measurement values of the sensor elements, corresponding shape changes may be determined or calculated. On the basis of the shape changes, it is possible to determine/calculate control or regulation signals which compensatingly counteract the specifically existing shape change when applied to the actively shape-variable material, in particular to one or more actuator units.

According to some embodiments, a control, for example with at least one control unit, may furthermore be provided. The control, or the at least one control unit, is adapted in such a way that it allows control-technological shape adaptation of the optics frame by adaptation of the actively shape-variable material. The control-technological shape adaptation may in this case be carried out on the basis of the sensor signals of the at least one sensor unit. Instead of the sensor signals or in addition thereto, one or more values or (physical) quantities derived from the sensor signals may also be used. When a control is implemented, the sensor signals, or the derived values or quantities, may be used as a command quantity of the control. Furthermore, one or more predetermined control parameters may be provided in addition to the command quantity.

In some configurations, the control may be adapted in such a way that it determines a quantity characteristic of the temperature of the optics frame, a quantity characteristic of a length change of the optics frame and/or a quantity characteristic of a volume change of the optics frame from the sensor signals, and uses this quantity as a command quantity. Besides or as an alternative to the temperature per se, other quantities may also be envisaged, in particular such quantities as are known to change as a function of temperature. For example, signals of piezo crystals and signals of the sensors and sensor types already mentioned above may be employed.

According to some embodiments, the seeker optics may comprise a regulation, for example with at least one regulation unit. The regulation, in particular the at least one regulation unit, is adapted for regulation-technological shape adaptation of the optics frame. The regulation-technological shape adaptation may, for example, be carried out by adaptation of the actively shape-variable material on the basis of the sensor signals, in particular on the basis of sensor signals according to the description above relating to the control by using the sensor signals as a regulation quantity or control quantity of the regulation. As an alternative or in addition to the sensor signals, one or more values or (physical) quantities derived from the sensor signals may also be used. The sensor signals and/or the derived values or quantities may be used as a regulation quantity of the regulation. In addition to the control quantity, one or more regulation parameters may be specified for the regulation.

Image signals, or quantities derived from images or image signals, which are recorded by means of an image acquisition unit of the seeker head, or of the seeker optics, may in particular also be used as sensor signals or regulation quantities or control quantities for the regulation. For example, imaging errors contained in the image signals or recorded images may be determined, and the imaging errors determined, or one or more quantities describing the imaging errors, or values derived therefrom, may be used as a control or regulation quantity. In this case, with a corresponding control or regulation unit, suitable algorithms for image processing which make it possible to determine imaging errors, in particular thermally induced imaging errors, may be implemented.

The derived value in the implementation of a regulation may, for example, be values or (physical) quantities which are characteristic of the shape of the optics frame or of the shape of segments of the optics frame and/or shape changes. In a way corresponding to the comments relating to the control, in the regulation as well, the signals of the aforementioned sensor units or sensor elements, or quantities derived therefrom, may be employed for the regulation.

A control or regulation of the shape of the optics frame allows, in particular, relatively accurate and direct adjustment of the location, position and/or shape of the optical elements in the optical system, in particular taking place substantially in real time. Correspondingly, for example, an imaging error in the optical system, caused by position and/or shape changes of the optical elements, may be corrected or compensated for. A seeker head equipped with corresponding seeker optics to this extent allows relatively accurate acquisition/tracking of objects which is substantially independent of external influences, for example temperature changes. With corresponding regulation or control and the prompt adaptations of the optics frame which are thereby possible, in particular taking place in real time, the seeker optics are suitable in particular for use in missiles, in particular guided missiles, in the scope of target guidance of the missile onto an object.

According to some embodiments, the optical system of the seeker optics may comprise multistage, in particular two-stage, optics. In the case of multistage optics, the at least one optics frame may hold at least one optical element of at least one stage of the multistage optics. In particular, the at least one optical element may be held in or on a section of the optics frame in which the actively shape-variable substance is present. Correspondingly, the location, in particular the position and alignment, and/or shape of the optical element may be adapted by an adaptive shape change of the shape variable substance.

In particular, in some configurations, is possible for the optical system to comprise two-stage optics in which the first stage forms reflective optics, in particular mirror optics having a plurality of mirrors, in particular a mirror telescope, and in which the second stage is configured as refractive optics, containing in particular one or more lenses and/or prisms. In particular, the reflective optical elements of the first stage whose location, in particular position and alignment, and/or shape are crucial for the imaging accuracy, particularly in seeker optics, may be held by the actively shape-variable material of the optics frame, so that location and/or shape changes caused by external influences, such as temperature changes, may be compensated for.

According to some embodiments, the optical system may comprise a mirror telescope having a primary mirror and a secondary mirror. The optics frame assigned to the mirror telescope may form a spacer for separating the primary mirror and the secondary mirror. The optics frame may in this case be configured in such a way that the relative location, in particular the distance, of the primary mirror and the secondary mirror and/or their shape can be adaptively varied by the actively shape-variable material in order to compensate for thermally induced and/or acceleration-induced distance changes, in particular caused by the movement dynamics of the optical system, and/or in order to compensate for manufacturing and adjustment tolerances. In this case, the actively shape-variable material may in particular be integrated into the optics frame at suitable sites, or the optics frame or the spacer may substantially as a whole be produced from or consist of the actively shape-variable material.

In some configurations, a seeker head having two-stage reflective-refractive optics may be provided, in which the reflective optics of the mirror telescope, which are relatively susceptible to temperature variations and dynamic stresses, can be adapted in location and shape to the respectively prevailing conditions. It is therefore possible, in particular, to provide a seeker head whose optical system is relatively robust against temperature variations at least in a given temperature interval, for example for temperatures in the range of between −55° C. and +85° C.

In some configurations, a seeker head which in particular has an interface for mounting on a missile, in particular a guided missile is provided. The seeker head contains at least one set of seeker optics according to at least one of the embodiments and configurations proposed here according to the invention.

In some configurations, a missile, in particular a guided missile, which contains at least one seeker head and/or at least one set of seeker optics according to at least one of the embodiments and configurations proposed here according to the invention, is provided.

Exemplary configurations of the invention are described below with the aid of the appended figures.

Other features which are considered as characteristic for the invention are set forth in the appended claims.

Although the invention is illustrated and described herein as embodied in seeker optics, a seeker head and a guided missile, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a seeker head according to the invention;

FIG. 2 is a perspective view of a first optical stage of the seeker head with an optics frame;

FIG. 3 is a perspective view of the optics frame according to FIG. 2;

FIG. 4 is a schematic representation of a control loop for adaptive variation of the optics frame;

FIG. 5 is a schematic representation of a regulation loop for adaptive variation of the optics frame; and

FIG. 6 is an illustration of a (guided) missile with the seeker head.

### DETAILED DESCRIPTION OF THE INVENTION

The following is a summary list of reference numerals and the corresponding structure used in the above description of the invention:

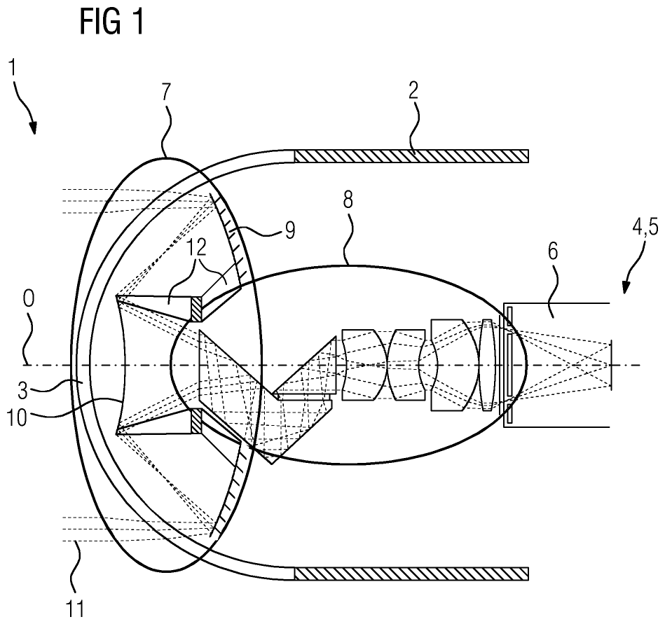

Referring now to the figures of the drawings in detail and first, particularly to FIG. 1 thereof, there is shown a cross-sectional representation of a seeker head 1 having a housing 2. At the end, the housing 2 has a viewing window 3, which is convexly curved as seen from inside the housing, for seeker optics 4 having an optical system 5, which are located inside the housing.

The seeker head 1, or the seeker optics 4, comprise for example an infrared-sensitive detector 6, i.e. a detector 6 which is sensitive to infrared radiation. In front of the detector 6 in the optical system of the seeker head, there are two-stage optics having a reflective first stage 7 and a refractive second stage 8. Merely for purposes of visual representation, the stages of the optics are respectively highlighted by an ellipse enclosing them.

The reflective first stage 7 of the two-stage optics comprises a primary mirror 9 and a secondary mirror 10, the arrangement of which corresponds to that of a mirror telescope. Infrared radiation 11 on the seeker head 1 incident from the outside through the seeker window 3 strikes the primary mirror 9, or more precisely a concavely curved mirror surface of the primary mirror 9, by which the incident infrared radiation 11 is focussed onto the secondary mirror 10. The secondary mirror 10 contains a convexly curved mirror surface, which is arranged in the beam path in such a way that the incident infrared radiation focussed by the primary mirror 9 is guided, or focussed, further onto the refractive second stage 8 of the two-stage optics.

The refractive second stage 8 contains a plurality of optical elements, inter alia prismatic optical elements and lenses, which are arranged and positioned along the optical axis O in such a way that the infrared radiation fed into the second stage 8 by the secondary mirror is imaged onto the detector 6. On the basis of the image of the infrared radiation on the detector 6, the seeker head 1 may for example identify and/or track a potentially relevant target or object, and to this extent generate data for targeted control of a missile.

The accuracy of the seeker head 1 for the identification and tracking of a target or object depends, in particular, on the imaging characteristics and imaging accuracy of the optical system 5. The imaging characteristics/imaging accuracy of the optical system 5 may in turn be crucially detrimentally influenced by external influencing factors, for example the temperature or temperature changes.

For example, the relative location of the optical elements with respect to one another or their position relative to the optical axis O and/or their shape may be varied by thermal expansion or contraction, or other external influences such as acceleration forces. Such variations may crucially degrade the imaging characteristics of the optical system 5, entailing a reduction of the accuracy of the object or target acquisition or tracking.

In order to counteract such variations in location and/or position of the optical elements and/or in shape, the optical system 5 of the seeker head 1 of FIG. 1 contains an optics frame 12 with which, in the present exemplary embodiment, in particular the primary mirror 9 and the secondary mirror 10 are held, the optics frame 12 containing an actively shape-variable substance by which at least the location, in particular position and/or alignment, of the primary and secondary mirrors 9 and 10 in the optical system 5 can be adaptively varied at least in a direction parallel to the optical axis.

In some configurations, the actively shape-variable substance may also be provided in such a way that the optical elements of the refractive second stage 8 can be adaptively varied in their location, in particular position, in, transversely and/or rotationally with respect to the optical axis, and/or in their shape. Such configurations may be implemented in a similar way to the exemplary embodiment described below, in which case adaptation of the location of the optical elements may correspondingly be applied separately for each stage of the optics or for the optics as a whole.

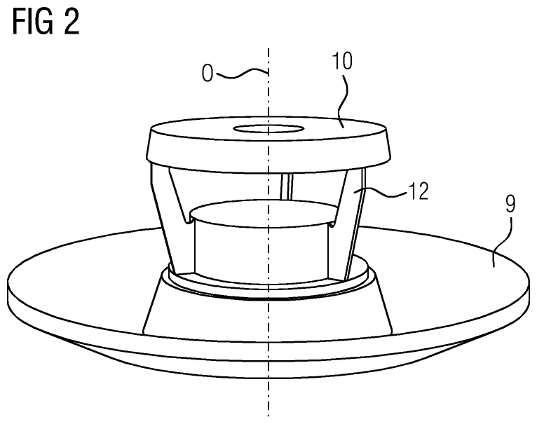

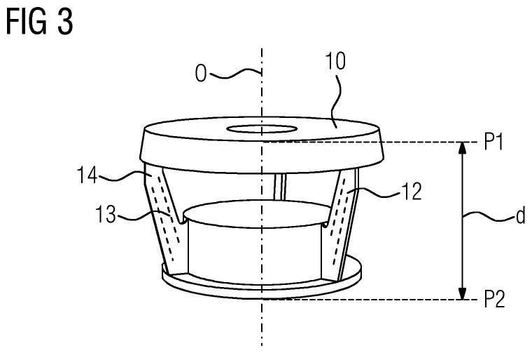

The optics frame 12 of the reflective first stage 7 of the optical system 5 is represented in further detail in FIGS. 2 and 3.

FIG. 2 shows a perspective representation of the optics frame 12, the optics frame 12 in the present example forming a frame or holder, which on the one hand holds the two mirrors 9, 10 and on the other hand positions the mirrors at a predetermined distance from one another, particularly in the direction of the optical axis O. To this extent and in particular, the optics frame 12 forms a spacer for the optical elements 9, 10 of the mirror telescope of the reflective first stage 7 of the optical system 5. Such spacers are also referred to as spiders in the context of mirror telescopes.

Particularly in order to compensate for length changes, for example distance changes, of the mirrors 9, 10 of the reflective first stage 7, for example caused by temperature changes, in particular by a change in the ambient temperatures or by other external effects during use of the seeker head, the optics frame 12, or the spider 12, has the aforementioned actively shape-variable substance.

In the exemplary embodiment of FIG. 3, the actively shape-variable substance contains piezoelectric crystals 13, which are embedded with a given alignment or preferential direction in the volume material of the spider 12. Although the exemplary embodiment is described with the aid of piezoelectric crystals 13, the comments below also apply similarly for other actively shape-variable substances, for example in general inverse piezoactive materials, electro- and/or magnetostrictive materials, etc., as already described above in general.

Specifically, and particularly as may be seen from FIG. 3, the piezoelectric crystals are embedded in the volume material of the spider arms 14 which are present between respective holding segments or the primary mirror 9 and the secondary mirror 10. The volume material may, for example, be a fiber-reinforced plastic material. In further configurations, piezoelectric crystals may also be present in other segments or regions of the spider 12, or of the optics frame, so that the location or position and/or shape of the optical elements can be varied in corresponding segments.

The piezoelectric crystals 13 are embedded according to the given preferential direction in such a way that the extent of the arms 14 of the spider 12 in the direction of the optical axis can be actively varied by applying an electrical voltage to the piezoelectric crystals 13. The extent of the arms 14 in the direction of the optical axis O can therefore be adaptively varied. With the adaptive variation of the extent of the material in the direction of the optical axis O, in particular the length of the arms 14 in the direction of the optical axis can be varied. With adaptation of the length of the arms 14, in particular the positions P1 and P2 of the mirrors 9, 10 and their relative location, i.e. the mutual distance d, may in particular be adjusted.

With the variation of the distance d, for example a position change of the mirrors 9, 10 caused by thermal expansion or contraction when the ambient temperature changes may be counteracted. In particular, the distance d may be adjusted by corresponding driving or regulation of the piezo crystals 13 in such a way that the mirrors 9, 10 are adjusted according to a respectively predetermined setpoint value.

Besides the piezoelectric crystals 13 aligned substantially parallel to the optical axis O as shown in the figures, in predetermined regions or segments of the optics frame 12 they may also be embedded transversely, in particular perpendicularly, with respect to the optical axis O. Furthermore, the piezoelectric crystals 13 may also be embedded outside the arms 14. The effect achievable by suitable embedding of the piezoelectric crystals is that the optics frame can be adapted in shape in such a way that the location, in particular position and/or alignment, and/or shape of the optical elements can be adjusted, i.e. adapted, parallel, transversely and/or rotationally with respect to the optical axis O.

With suitable embedding of the piezoelectric crystals and suitable materials of the optical elements, it is also suitable to achieve the effect that the shape of the optical elements can be varied. For example, the shape of the parts of the optics frame 12 which hold the optical elements may be adapted by piezoelectric crystals, laid longitudinally and/or transversely with respect to the optical axis, generating deformation forces. On the basis of the shape change of the optics frame, the shape of the optical elements, for example of the mirrors 9, 10, may in turn be varied or adapted.

It follows from this that, by corresponding application of an electrical voltage to the piezoelectric crystals 13, a position and/or shape change caused by thermal expansion or contraction of the material of the optics frame may be counteracted. In particular, changes in the distances between the optical elements, caused by temperature variations, may be compensated for. Similarly, changes in the refractive index of the surrounding medium, or other external influences which degrade the optical imaging properties of the optical system 5, for example (installation) tolerances, movement-induced shape changes (for example caused by missile movements and associated accelerations), moisture, etc., may also be compensated for.

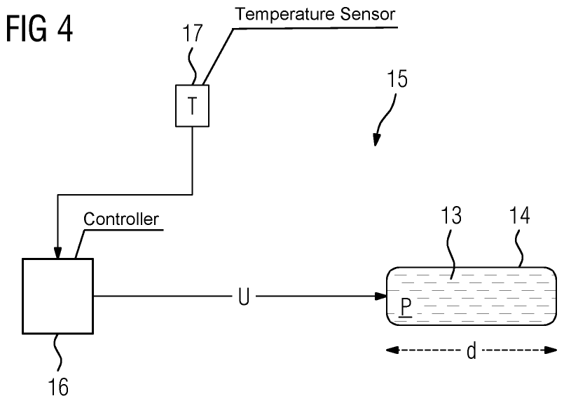

FIG. 4 shows a schematic representation of a control loop 15 for the adaptive variation of the optics frame 12. The control loop 15 may for example be accommodated in the seeker head 1, and in particular implemented in a seeker head control.

The control loop 15 contains a control unit 16, which is connected or coupled by signal technology on the one hand to a temperature sensor 17 and on the other hand to the optics frame 12, for example to the arms 14 of the optics frame 12. In particular, the control unit 16 is coupled to the region of the optics frame 12 in which the piezoelectric crystals for forming the adaptively shape-variable properties are embedded. This region will also be referred below to as the piezo region P for brevity. In this case, the signal-technological electrical connection between the control unit 16 and the piezo region P is adapted in such a way that the control unit 16 can apply a voltage U to the piezo region P. The length of the piezoelectric crystals 13 in the piezo region P changes according to the level of the voltage U, so that a shape change, in particular a length change, is induced, particularly in the region of the arms 14 of the optics frame 12.

The control unit 16 is adapted in such a way that, as a function of the sensor signals of the temperature sensor 17 for the respectively measured ambient temperature T, abbreviated below to temperature T, it determines a voltage U which must be applied to the optics frame 12, in particular the piezo region P, so that a thermally induced expansion or contraction of the optics frame 12 can be counteracted by a corresponding length change of the piezoelectric crystals 13. To this end, the control unit 16 may for example be correspondingly programmed and, in particular on the basis of thermal expansion coefficients, determine a voltage U suitable for the respectively measured temperature T, with which the thermal contraction/expansion at the measured temperature relative to a reference temperature can be compensated for by the length change of the piezoelectric crystals. In the present exemplary embodiment, the temperature T measured by the temperature sensor 17 is used as a command quantity for the control loop. The distance d may therefore be varied by control technology, which means that, in particular, the mutual distance of the optical elements can be adaptively varied, and in particular can be adjusted within a certain scope.

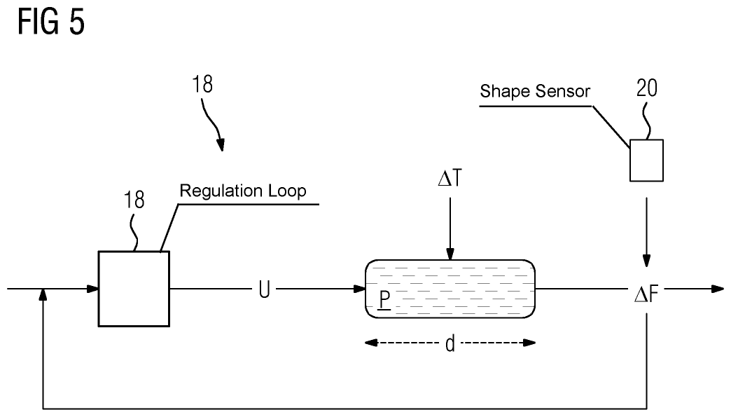

In some configurations, for example according to FIG. 5, the seeker head 1 may comprise a regulation loop 18, or a regulation loop 18 may be assigned to the seeker head 1 or to the seeker optics 4.

The regulation loop 18 may, in particular, be configured for regulation-technological shape adaptation of the optics frame 12. In particular, as schematically represented in FIG. 5, the regulation loop 18 may comprise a regulation section having a regulation unit 19 and a shape sensor unit 20 for recording shape changes ΔF of the optics frame 12, in particular of the piezo region P. For example, such a sensor unit may comprise strain gauge strips or piezo elements, which are for example embedded in the material of the optics frame 12 or connected thereto, and are adapted so that length changes in or transversely with respect to the optical axis O, in general shape changes of the optics frame 12 and/or of the optical elements, can be recorded.

As an alternative or in addition, the regulation loop 18 may also be adapted, in particular programmed, so that shape changes of the optics frame 12 can be determined or established on the basis of the imaging errors of the seeker optics 4.

In the regulation section, the shape change ΔF and/or one or more quantities describing the imaging error or errors may for example be used as a regulation quantity, and according to the regulation quantity which is fed back, the regulation unit may determine a respectively suitable voltage U with which shape changes of the optics frame 12, caused by temperature changes ΔT or other external influences, may be compensated for.

As already indicated, in some exemplary embodiments, an imaging error or a quantity describing the imaging error, which may be determined for example by correspondingly implemented algorithms from image data that have been/are recorded by the seeker optics, may be used as a regulation quantity in the regulation section. Correspondingly, with the regulation section it is possible to compensate for, or eliminate, imaging errors which are caused by a shape or location/position change, for example due to temperature changes or other external influences. In particular, a regulation section allows substantially continuous, or at least iteratively adaptive, correction of location changes and/or shape changes of the optics frame, or of the optical elements, and therefore iteratively adaptive correction of imaging errors in image data of the seeker optics.

In a similar way as for the control section, at least over a certain temperature range, the regulation section allows adjustment of a predetermined setpoint distance between the optical elements held by the optics frame 12, or the adjustment of a respective setpoint shape. In particular, thermally induced degradations of the imaging accuracy, or degradations caused in another way by external influences, may be compensated for by a control loop 15 or regulation loop 18.

Particularly advantageously, the optics frame comprises a fiber-reinforced plastic material, for example a fiber-reinforced epoxy resin. Such a material allows relatively simple embedding of inverse piezoactive materials, in particular piezoelectric crystals, and/or electrostrictive materials. Materials having magnetostrictive properties may also be envisaged, so that location/position and/or shape changes may be compensated for on the basis of the magnetostrictive properties.

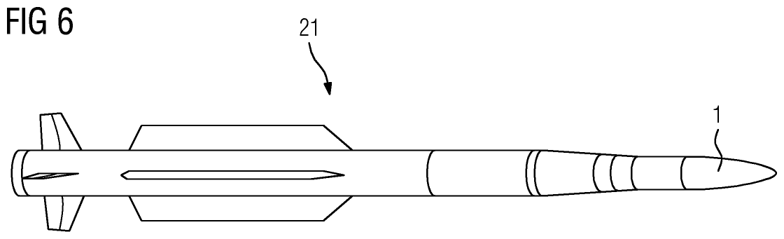

Lastly, FIG. 6 shows a missile 21 known per se, in particular a guided missile 21, having a seeker head 1 according to one configuration of the invention. The seeker head 1 is positioned on a nose of the guided missile 21 facing away from the propulsion side, for example on the basis of a mounting interface for mounting the seeker head 1 on the fuselage of the guided missile 21.

### LIST OF REFERENCES

1 seeker head
2 housing
3 viewing window
4 seeker optics
5 optical system
6 detector
7 reflective first stage
8 refractive second stage
9 primary mirror
10 secondary mirror
11 infrared radiation
12 optics frame
13 piezoelectric crystals
14 arm
15 control loop
16 control unit
17 temperature sensor
18 regulation loop
19 regulation unit
20 shape sensor unit
21 missile
d distance
ΔF shape change
O optical axis
Pi position
P piezo region
ΔT temperature change
T temperature

1. Seeker optics for a missile seeker head, the seeker optics comprising:
an optical system having at least one optical element being aligned so as to be positioned with respect to an optical axis; and
at least one optics frame holding said at least one optical element, said at least one optics frame having an actively shape-variable substance by which a location of said at least one optical element in said optical system can be varied relative to the optical axis and/or by which a shape of said at least one optical element can be adaptively varied.

2. The seeker optics according to claim 1, wherein said actively shape-variable substance of said at least one optics frame contains a fiber-reinforced substance material, the fiber-reinforced substance material forming a matrix in which fibers are embedded.

3. The seeker optics according to claim 2, wherein:
said fibers contain carbon fibers, glass fibers and/or basalt fibers; or
said fibers are carbon fibers, glass fibers and/or basalt fibers.

4. The seeker optics according to claim 2, wherein said fiber-reinforced substance material:
contains at least one material selected from the group consisting of epoxy resins, vinyl ester resins, polyurethanes, polyether ketones, and polyether ether ketones; or
consists of at least one material selected from the group.

5. The seeker optics according to claim 1, wherein said actively shape-variable substance forms an actuator unit, which for an active shape variation contains at least one inverse piezoactive material, at least one electrostrictive material and/or at least one magnetostrictive material.

6. The seeker optics according to claim 1, wherein said actively shape-variable substance forms an actuator unit having inverse piezoactive materials.

7. The seeker optics according to claim 1, further comprising at least one sensor unit being adapted to measure an ambient temperature and/or to generate sensor signals characteristic of shape variations of said at least one optics frame.

8. The seeker optics according to claim 7, wherein said sensor unit contains piezoelectric crystals, piezoelectric fibers and/or at least one resistive strain gauge strip, inductive displacement sensors, inductive distance sensors, magnetoelastic sensors, capacitive differential sensors and/or fiber-optic temperature sensors as sensor elements.

9. The seeker optics according to claim 7, further comprising a control loop which is adapted for control-technological shape adaptation of said at least one optics frame by adaptation of said actively shape-variable material on a basis of the sensor signals or of at least one value or quantity derived therefrom as a command quantity.

10. The seeker optics according to claim 9, wherein said control loop is adapted to determine a quantity characteristic of the ambient temperature, a quantity characteristic of a length change and/or a quantity characteristic of a volume change of said at least one optics frame from control signals, and to use a quantity as a command quantity.

11. The seeker optics according to claim 7, further comprising a regulation loop which is adapted for regulation-technological shape adaptation of said at least one optics frame by adaptation of said actively shape-variable material on a basis of the sensor signals or of at least one value or quantity derived therefrom as a regulation quantity.

12. The seeker optics according to claim 11, wherein a derived value is values or quantities characteristic of a shape of said at least one optics frame, of a shape of segments of said at least one optics frame or of corresponding shape changes.

13. The seeker optics according to claim 1, wherein said optical system contains multistage optics, and said at least one optics frame holds said at least one optical element of at least one stage of said multistage optics.

14. The seeker optics according to claim 13, wherein said multistage optics contains two-stage optics, including a first stage which forms reflective optics, and a second stage configured as refractive optics, said actively shape-variable material of said at least one optics frame holding optical elements of said first stage.

15. The seeker optics according to claim 1, wherein:
said optical system contains a mirror telescope having a primary mirror and a secondary mirror, and said at least one optics frame of said mirror telescope forms a spacer for separating said primary mirror and said secondary mirror; and
said at least one optics frame is configured in such a way that a relative location of said primary mirror and said secondary mirror can be adaptively varied by said actively shape-variable material in order to compensate for thermally induced and/or acceleration-induced distance changes and/or in order to compensate for manufacturing and adjustment tolerances.

16. The seeker optics according to claim 2, wherein said fiber-reinforced substance material is a fiber-reinforced plastic material, the fiber-reinforced plastic material forming the matrix in which the fibers are embedded

17. The seeker optics according to claim 6, wherein said inverse piezoactive materials include piezoelectric crystals and/or fibers as actuator elements, which are embedded in a volume material of said at least one optics frame while being aligned according to at least one preferential direction.

18. The seeker optics according to claim 7, wherein said at least one sensor unit is at least partially embedded in a volume material of said at least one optics frame and/or applied on a surface of said at least one optics frame.

19. A seeker head, comprising:
an interface for mounting on a missile and containing at least one set of seeker optics, each of said seeker optics containing:
an optical system having at least one optical element being aligned so as to be positioned with respect to an optical axis; and
at least one optics frame holding said at least one optical element, said at least one optics frame having an actively shape-variable substance by which a location of said at least one optical element in said optical system can be varied relative to the optical axis and/or by which a shape of said at least one optical element can be adaptively varied.

20. A missile, comprising:
at least one seeker head having an interface for mounting on the missile and containing at least one set of seeker optics, each of said seeker optics containing:
an optical system having at least one optical element being aligned so as to be positioned with respect to an optical axis; and
at least one optics frame holding said at least one optical element, said at least one optics frame having an actively shape-variable substance by which a location of said at least one optical element in said optical system can be varied relative to the optical axis and/or by which a shape of said at least one optical element can be adaptively varied.
